(19) United States
(12) Patent Application Publication
(10) Pub. No.: US 2025/0189786 A1
(43) Pub. Date: Jun. 12, 2025

(54) HEAD-UP DISPLAY ARCHITECTURE AND TRANSPORT VEHICLE FRONT WINDSHIELD STRUCTURE

(71) Applicant: AUO Corporation, Hsinchu City (TW)

(72) Inventors: Yueh-Heng Lee, Hsinchu City (TW); Chia-Hung Chen, Hsinchu City (TW); Kuo-Yen Chang, Hsinchu City (TW); Guang-Fu Wang, Hsinchu City (TW); Yen-Ju Huang, Hsinchu City (TW)

(21) Appl. No.: 18/903,001

(22) Filed: Oct. 1, 2024

Related U.S. Application Data
(60) Provisional application No. 63/608,836, filed on Dec. 12, 2023.

(30) Foreign Application Priority Data
Jan. 8, 2024 (TW) 113100792

(51) Int. Cl. G02B 27/01; G02B 27/00

(52) U.S. Cl. CPC G02B 27/0101; G02B 27/0012; G02B 27/0018; G02B 2027/0118; G02B 2027/013

(57) ABSTRACT

Disclosed is a head-up display (HUD) architecture for a transport vehicle, including a transport vehicle front windshield structure and a display apparatus. The display apparatus is arranged on a side of the transport vehicle front windshield structure facing an interior of the transport vehicle and includes a display surface facing the transport vehicle front windshield structure. Image light is emitted by the display apparatus toward the transport vehicle front windshield structure in a propagation direction and reflected to an ocular point of a driver on the side of the transport vehicle front windshield structure facing the interior of the transport vehicle. A light emitting angle is defined between the propagation direction and a normal direction of the display surface. A peak value of intensity distribution of the light emitting angle is located outside the normal direction of the display surface.

### CROSS-REFERENCE TO RELATED APPLICATION

This application claims the priority benefits of U.S. provisional application Ser. No. 63/608,836 filed on Dec. 12, 2023 and Taiwan application serial no. 113100792 filed on Jan. 8, 2024. The entirety of the above-mentioned patent applications is hereby incorporated by reference herein and made a part of this specification.

### TECHNICAL FIELD

The present invention relates to a head-up display (HUD) architecture for a transport vehicle and a transport vehicle front windshield structure.

### BACKGROUND

A HUD is a flight assistance instrument commonly used on an aircraft at present. Some vehicles are also equipped with a HUD, to project status information of the vehicle such as vehicle speed, rotation speed, engine water temperature, and fuel consumption on the front windshield for the driver to view.

Generally, a HUD architecture includes a front windshield and a display apparatus. The display apparatus is an existing display such as a liquid crystal display in most cases. The display apparatus displays an image including the status information of the vehicle, and the driver views an image reflected from the front windshield. However, conventional HUD architectures have problems such as low brightness, impact of reflection of an inside mirror and an outside mirror of a vehicle on the display effect, and failing to take the design of the vehicle body into consideration.

### SUMMARY

An objective of the present invention is to provide a HUD architecture for a transport vehicle, which has a good display effect.

The HUD architecture of the present invention includes a transport vehicle front windshield structure and a display apparatus. The display apparatus is arranged on a side of the transport vehicle front windshield structure facing an interior of the transport vehicle and includes a display surface facing the transport vehicle front windshield structure. Image light is emitted by the display apparatus toward the transport vehicle front windshield structure in a propagation direction and reflected to an ocular point of a driver on the side of the transport vehicle front windshield structure facing the interior of the transport vehicle, a light emitting angle is defined between the propagation direction and a normal direction of the display surface, and a peak value of intensity distribution of the light emitting angle is located outside the normal direction of the display surface.

In an embodiment, the display apparatus does not include an optical film configured to concentrate light emitted by a light source module toward a normal of the display surface.

In an embodiment, the display apparatus further includes a microstructure layer arranged on the display surface, the microstructure layer includes a plurality of microstructures arranged on a side of the microstructure layer opposite to the display surface, and each of the microstructures includes a bottom portion, a top portion, a first side surface, and a second side surface. The bottom portion is parallel to the display surface. The top portion is located above the bottom portion. The first side surface is inclined toward a driver from bottom to top from a side of the bottom portion close to the transport vehicle front windshield structure, and connected to a side of the top portion close to the transport vehicle front windshield structure, where an included angle between the first side surface and the display surface is defined as α. The second side surface is inclined toward the transport vehicle front windshield structure from bottom to top from a side of the bottom portion away from the transport vehicle front windshield structure, and connected to a side of the top portion away from the transport vehicle front windshield structure, where an included angle between the second side surface and the display surface is defined as β. α<β, a distance between the side of the top portion close to the transport vehicle front windshield structure and the side away of the top portion from the transport vehicle front windshield structure is defined as H1, a distance between the side of the bottom portion close to the transport vehicle front windshield structure and the side of the bottom portion away from the transport vehicle front windshield structure is defined as H2, and H1<H2.

In an embodiment, H1 is greater than or equal to 0, α>0, and β is less than or equal to 90°.

In an embodiment,

$${θ}_{C} = 90 ° - 2 {θ}_{A} + {θ}_{B} ,$$

$$α = {sin}^{- 1} ( \frac{1}{N} \times sin {θ}_{C} ) ,$$

θ_{A} is an included angle between the transport vehicle front windshield structure and a head-up sight of the driver,
θ_{B} is a predefined included angle downward relative to the head-up sight of the driver, and
N is a refractive index of the microstructure.

In an embodiment, the transport vehicle front windshield structure includes a front windshield and a composite film. The composite film is bonded to a side of the front windshield opposite to the driver, where the composite film includes a plurality of different thermoplastic resin films arranged in a stack.

In an embodiment, in a case that reflectivity (%) of each P wave incident at a first angle, a second angle greater than the first angle, and a third angle greater than the second angle relative to a normal of a film surface is defined as R_{θ1}, R_{θ2}, and R_{θ3}, a relationship of R_{θ1}≤R_{θ2}<R_{θ3} is met, where

$$angle A = \frac{( 180 - {θ}_{A} )}{2} ,$$

$$angle I = \frac{( 180 - {θ}_{I} )}{2} ,$$

θ_{A} is an included angle between the transport vehicle front windshield structure and a head-up sight of the driver,
θ_{I} is an included angle between the image light and the display surface,
angle A>angle I,
reflectivity at angle A<reflectivity at angle I, and
transmittance at angle A>transmittance at angle I.

In an embodiment, the transport vehicle front windshield structure further includes an inner glass bonded to a side of the composite film opposite to the driver, and a thickness of the inner glass is less than a thickness of the front windshield.

In an embodiment, the transport vehicle front windshield structure further includes an inner glass, where the front windshield and the composite film are bonded by a first adhesive layer, the composite film and the inner glass are bonded by a second adhesive layer, and a thickness of the first adhesive layer and a thickness of the second adhesive layer are less than a thickness of the front windshield.

### BRIEF DESCRIPTION OF THE DRAWINGS

FIG. 1 is a schematic diagram of a HUD architecture according to an embodiment of the present invention.

FIG. 2 is a schematic diagram in which light emitted by a display apparatus in a HUD architecture is divergent according to an embodiment of the present invention.

FIG. 3 is a schematic diagram in which light emitted by a light source module in a HUD architecture deviates toward a user according to an embodiment of the present invention.

FIG. 4A is a schematic diagram of a microstructure layer in a HUD architecture according to an embodiment of the present invention.

FIG. 4B is a schematic top view of a microstructure in a HUD architecture according to the present invention.

FIG. 4C is a cross-sectional view along AA′ in FIG. 4B.

FIG. 5 is a schematic diagram of a HUD architecture in which a transport vehicle front windshield structure includes a front windshield and a composite film according to another embodiment of the present invention.

FIG. 6 and FIG. 7 are each a schematic diagram of a HUD architecture in which a transport vehicle front windshield structure includes a front windshield, a composite film, and an inner glass according to another embodiment of the present invention.

FIG. 8A to FIG. 8C are each a schematic diagram showing reflection of image light to form light forming a main image and a ghost image according to an embodiment of the present invention.

### DETAILED DESCRIPTION

Implementations of a connection assembly disclosed by the present invention are described below by using particular and specific embodiments with reference to the drawings, and a person skilled in the art may learn of advantages and effects of the present invention from the disclosure of this specification. However, the following disclosure is not intended to limit the protection scope of the present invention, and a person skilled in the art may carry out the present invention by using other different embodiments based on different viewpoints without departing from the concept and spirit of the present invention. In the accompanying drawings, plate thicknesses of layers, films, panels, regions, and the like are enlarged for clarity. Throughout the specification, same reference numerals indicate same elements. It should be understood that when an element such as a layer, film, region or substrate is referred to as being “on” or “connected” to another element, it may be directly on or connected to the another element, or intervening elements may also be present. In contrast, when an element is referred to as being “directly on” or “directly connected to” another element, there is no intervening element present. As used herein, “connection” may refer to a physical and/or electrical connection. Further, “electrical connecting” or “coupling” may indicate that another element exists between two elements.

It should be noted that the terms “first”, “second”, “third”, and the like that are used in the present disclosure can be used for describing various elements, components, regions, layers and/or portions, but the elements, components, regions, layers and/or portions are not limited by the terms. The terms are merely used to distinguish one element, component, region, layer, or portion from another element, component, region, layer, or portion. Therefore, the “first element”, “component”, “region”, “layer”, or “portion” discussed below may be referred to as a second element, component, region, layer, or portion without departing from the teaching of this disclosure.

In addition, relative terms, such as “down” or “bottom” and “up” or “top”, are used to describe a relationship between an element and another element, as shown in the figures. It should be understood that the relative terms are intended to include different orientations of a device in addition to orientations shown in the figures. For example, if a device in a figure is turned over, an element that is described to be on a “lower” side of another element is directed to be on an “upper” side another element. Therefore, the exemplary terms “down” may include orientations of “down” and “up” and depends on a particular orientation of an accompanying drawing. Similarly, if a device in a figure is turned over, an element that is described as an element “below” another element or an element “below” is directed to be “above” another element. Therefore, the exemplary terms “below” or “below” may include orientations of up and down.

As used herein, “about”, “approximately”, or “substantially” is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, ±20%, ±10%, ±5% of the stated value. Further, as used herein, “about”, “approximately”, or “substantially” may depend on optical properties, etch properties, or other properties to select a more acceptable range of deviations or standard deviations without one standard deviation for all properties.

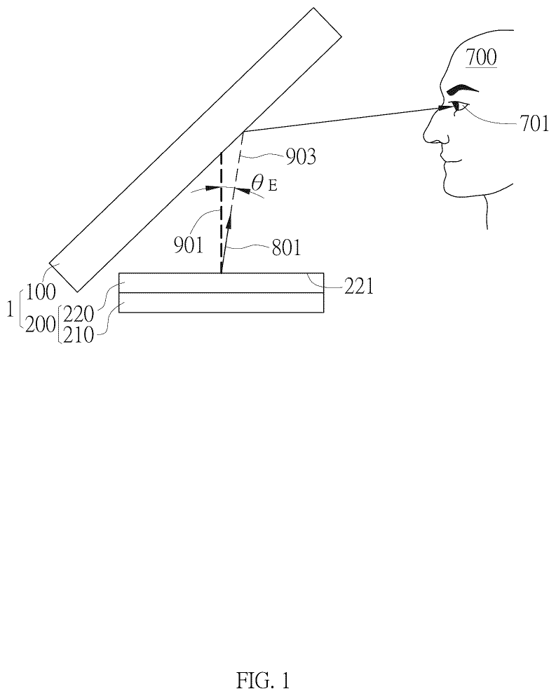

In an embodiment shown in FIG. 1, a HUD architecture 1 of the present invention is for use in a transport vehicle such as a vehicle, and includes a transport vehicle front windshield structure 100 and a display apparatus 200. The transport vehicle front windshield structure 100 may be a single-layer or multi-layer structure, and may be ordinary glass, tempered glass, or laminated glass. The display apparatus 200 is arranged on a side of the transport vehicle front windshield structure 100 facing an interior of the transport vehicle and includes a display surface 221 facing the transport vehicle front windshield structure 100. In an embodiment, the display apparatus 200 may include a light source module 210 and a display module 220. The light source module 210 may include a light-emitting unit such as a light-emitting diode (LED) or a micro light-emitting diode (μLED), and an optical film such as a diffusion plate. The display module 220 is arranged on the light source module 210, and may be, for example, a liquid crystal display module. The display module 220 includes the display surface 221 arranged on a side of the display module 220 opposite to the light source module 210. Image light 801 is emitted by the display apparatus 200 toward the transport vehicle front windshield structure 100 in a propagation direction 903 and reflected to an ocular point 701 of a user 700 on the side of the transport vehicle front windshield structure 100 facing the interior of the transport vehicle. A light emitting angle θE is defined between the propagation direction 903 and an extending direction of a normal 901 of the display surface 221. A peak value of intensity distribution of the light emitting angle θ_{E} is located outside the extending direction of the normal 901 of the display surface 221.

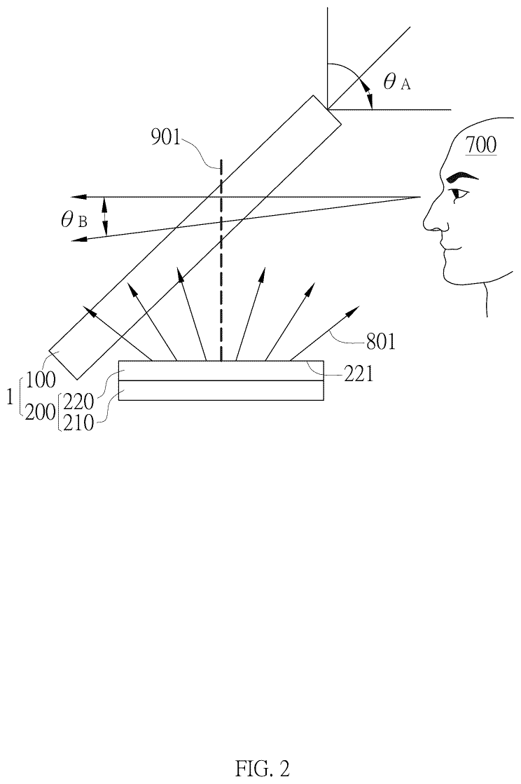

In particular, in an embodiment shown in FIG. 2, after the light emitted by the light source module 210 passes through the display module 220, the image light 801 emitted by the display apparatus 200 is substantially divergent, that is, substantially has no specific directionality. Different from conventional technologies, to achieve the above effect, the display apparatus 200 does not include an optical film such as a prism sheet or a bright enhancement film (BEF) for concentrating light emitted by the light source module 210 toward the normal 901 of the display surface 221. Further, in conventional technologies, a user usually views an image in front of a display surface of a display apparatus, and an optical film such as a prism sheet or a BEF is used in the display apparatus, to make the image light emitted by the display apparatus as perpendicular to the display surface as possible to improve brightness. Therefore, a technical prejudice that the brightness of the display apparatus has to be improved using an optical film such as a prism sheet or a BEF is established, and a person of ordinary skill in the art to which the present invention pertains is guided not to consider a possibility of not using an optical film. However, in an application environment of a HUD, the user does not directly watch the display apparatus, but views a HUD image generated by the image light emitted by the display apparatus and reflected by the front windshield. When the image light emitted by the display apparatus is made as perpendicular to the display surface as possible, a large part of the image light directly passes through the front windshield without being reflected, which is not conducive to improving the brightness of the HUD image. The display apparatus 200 in the HUD architecture 1 of the present invention does not include the optical film for concentrating light toward the normal 901 of the display surface 221, thereby overcoming the prejudice in conventional technologies, increasing the brightness of the HUD image, and improving the display effect.

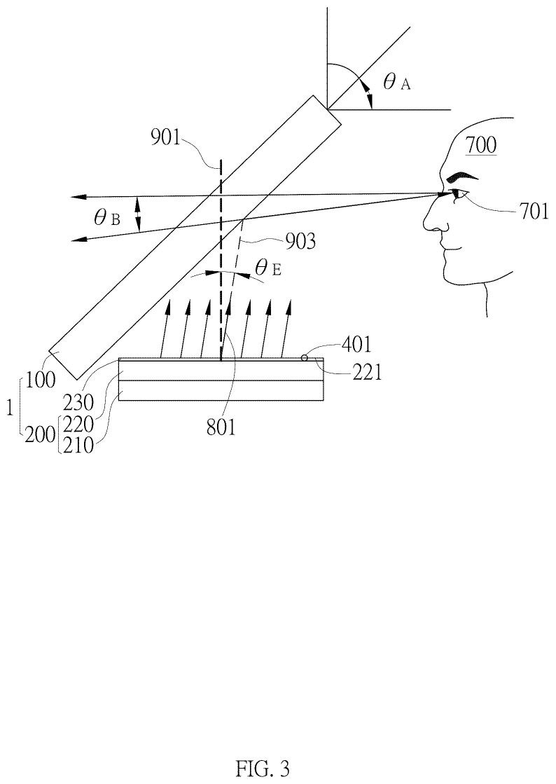

In some other embodiments, the technical effect that the peak value of the intensity distribution of the light emitting angle θ_{E} is located outside the extending direction of the normal 901 of the display surface 221 may be achieved in other manners. In an embodiment shown in FIG. 3, the display apparatus 200 further includes a microstructure layer 230 arranged on the display surface 221. The microstructure layer 230 includes microstructures, so that after the light emitted by the light source module 210 passes through the display module 220, the image light 801 emitted by the display apparatus 200 substantially deviates from the normal 901 of the display surface 901 toward the user 700, so that the peak value of the intensity distribution of the light emitting angle θ_{E} is located outside the extending direction of the normal 901 of the display surface 221. In the embodiment shown in FIG. 3, the microstructure layer 230 is used together with the display apparatus 200 that does not include the optical film for concentrating light. However, in some other embodiments, considering factors such as convenience, the microstructure layer 230 may also be used together with an ordinary display apparatus that includes an optical film such as a prism sheet and a BEF.

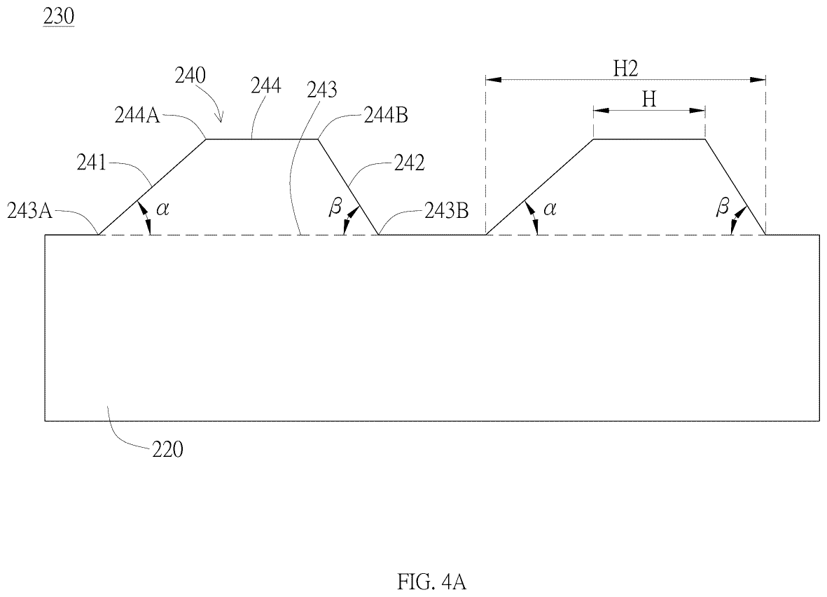

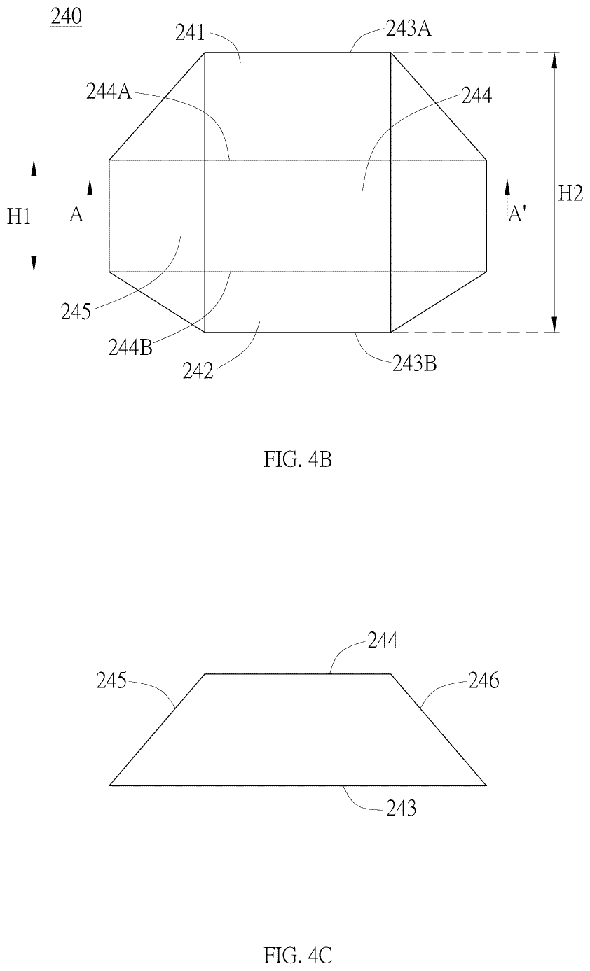

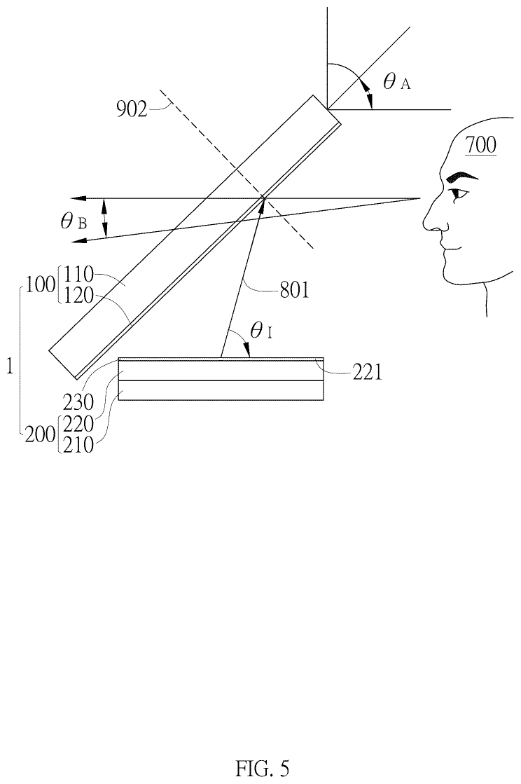

In particular, FIG. 4A shows an enlarged view of a region 401. The microstructure layer 230 includes a plurality of microstructures 240 arranged on a side of the microstructure layer 230 opposite to the display surface 221 (referring to FIG. 3). Further, FIG. 4B is a top view of the microstructure 240, and FIG. 4C is a cross-sectional view along AA′ in FIG. 4B. Each of the microstructures 240 includes a bottom portion 243, a top portion 244, a first side surface 241, and a second side surface 242. The bottom portion 243 is parallel to the display surface 221. The top portion 244 is located above the bottom portion 243. The first side surface 241 is inclined toward the user 700 from bottom to top from a side 243A of the bottom portion 243 close to the transport vehicle front windshield structure 100 (referring to FIG. 3), and is connected to a side 244A of the top portion 244 close to the transport vehicle front windshield structure 100. An included angle between the first side surface 241 and the bottom portion 243 is defined as α. Since the bottom portion 243 is parallel to the display surface 221, an included angle between the first side surface 241 and the display surface 221 is substantially a. The second side surface 242 is inclined toward the transport vehicle front windshield structure 100 from bottom to top from a side 243B of the bottom portion 243 away from the transport vehicle front windshield structure 100, and is connected to a side 244B of the top portion 244 away from the transport vehicle front windshield structure 100. An included angle between the second side surface 242 and the bottom portion 243 is defined as β, and α<β. Since the bottom portion 243 is parallel to the display surface 221, an included angle between the second side surface 242 and the display surface 221 is substantially B. A distance between the side 244A of the top portion 244 close to the transport vehicle front windshield structure 100 and the side 244B of the top portion 244 away from the transport vehicle front windshield structure 100 is defined as H1, a distance between the side 243A of the bottom portion 243 close to the transport vehicle front windshield structure 100 and the side 243B of the bottom portion 243 away from the transport vehicle front windshield structure 100 is defined as H2, and H1<H2. H1 is greater than or equal to 0, α>0, and β is less than or equal to 90°. In other words, H1 may be 0, that is, H1 may be linear.

In the embodiment shown in FIG. 3, the microstructures 240 may meet the following conditions to achieve a more desirable light deflection effect.

$${θ}_{C} = 90 ° - 2 {θ}_{A} + {θ}_{B} ,$$

$$α = {sin}^{- 1} ( \frac{1}{N} \times sin {θ}_{C} ) ,$$

θ_{A} is an included angle between the transport vehicle front windshield structure 100 and a head-up sight of the user 700 such as a driver,
θ_{B} is a predefined included angle downward relative to the head-up sight of the user 700 such as a driver, and
N is a refractive index of the microstructure 240.

The microstructures 240 may be formed during the formation of the microstructure layer 230 by injection forming, or may be formed after the formation of the microstructure layer 230, for example, by depositing the same material as that of the microstructure layer 230 by chemical vapor deposition or by removing part of the microstructure layer 230 by etching, machining, sandblasting, or other methods.

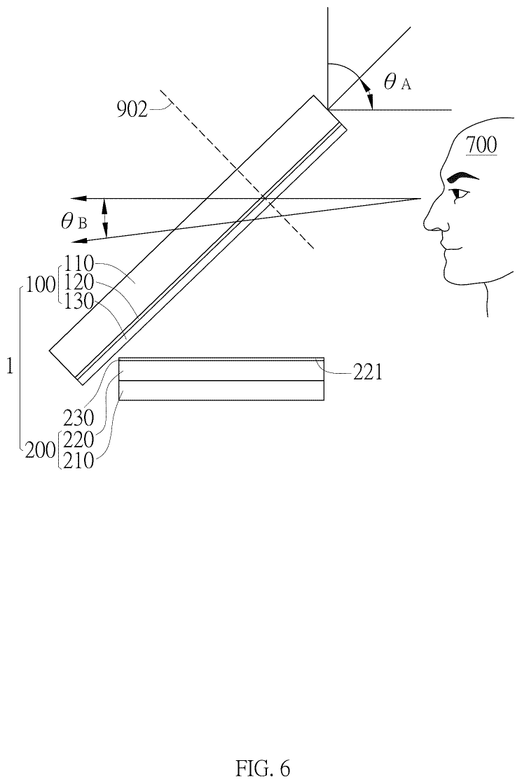

In an embodiment shown in FIG. 5, the transport vehicle front windshield structure 100 in the HUD architecture 1 of the present invention may include a front windshield 110 and a composite film 120. The composite film 120 is bonded to a side of the front windshield 110 opposite to the user 700, and includes a plurality of thermoplastic resin films with different thicknesses and different refractive indexes that are arranged in a stack. For example, the settings of different thicknesses and different refractive indexes cause light (that is, the image light 801) incident on the transport vehicle front windshield structure 100 to generate a significant degree of destructive interference, so that reflectivity of the incident light is increased, thereby improving the brightness of an image projected by the display apparatus 200 to the ocular point 701.

In addition, in the embodiment shown in FIG. 5, to achieve relatively high brightness of the projected image, but relatively low reflectivity of light projected from an object outside the vehicle to the ocular point 701, and relatively low reflectivity of light projected from an object in the vehicle (such as a dashboard and a central control screen for audio and video entertainment) to the ocular point 701, proportions of destructive interference at different incident angles are further designed in the present invention. In this way, the reflectivity at different incident angles can be adjusted. Specifically, in a case that reflectivity (%) of each P wave incident on the composite film 120 at a first angle, a second angle greater than the first angle, and a third angle greater than the second angle relative to a normal 902 of a film surface is defined as R_{θ1}, R_{θ2}, and R_{θ3}, a relationship of R_{θ1}≤R_{θ2}<R_{θ3} is met, where

$$angle A = \frac{( 180 - {θ}_{A} )}{2} ,$$

$$angle I = \frac{( 180 - {θ}_{I} )}{2} ,$$

θ_{A} is an included angle between the transport vehicle front windshield structure 100 and the head-up sight of the user 700,
θ_{I} is an included angle between the image light 801 and the display surface 221, angle A>angle I,
reflectivity at angle A<reflectivity at angle I, and
transmittance at angle A>transmittance at angle I.

Further, the HUD architecture 1 of the present invention can further reduce reflection of an inside mirror and/or an outside mirror of the vehicle by changing the relative relationship between film stacking, the incident angle, and transmittance and considering an included angle between the transport vehicle front windshield structure 100 and ground and the position of the ocular point of the driver. In an embodiment, compared with conventional technologies, the HUD architecture of the present invention not only reduces the reflection of the inside mirror and the outside mirror of the vehicle, but also increases the brightness of the HUD image by at least 3000%.

In particular, in an embodiment, the composite film 120 includes two thermoplastic resins. A resin forming a layer containing a first thermoplastic resin (i.e., layer A) includes a crystalline polyester resin. A resin forming a layer containing a second thermoplastic resin (i.e., layer B) is an amorphous polyester resin. A difference between in-plane refractive indexes of the layer A and the layer B is less than or equal to 0.04. A difference between glass transfer temperatures of the layer A and the layer B is less than or equal to 20° C. The thermoplastic resin forming the layer B includes a structure derived from an alkyleneglycol with a number average molecular weight of 200 or more. The first angle, the second angle, and the third angle are 20°, 40°, and 70° respectively. In this case, when the reflectivity (%) of each P wave incident at the angles of 20°, 40°, and 70° relative to the normal of the film surface is defined as R20, R40, and R70, the relationship of R20≤R40<R70 is met. Transmittance of light perpendicularly incident on the film surface is greater than or equal to 50%, the reflectance R70 is greater than or equal to 30%, and chrominance of reflected light of the P wave incident at an angle of 70° relative to the normal of the film surface is less than or equal to 20. However, in some other embodiments, the composite film 120 may have other structures or compositions that can meet the foregoing relationship of R_{θ1}≤R_{θ2}<R_{θ3}.

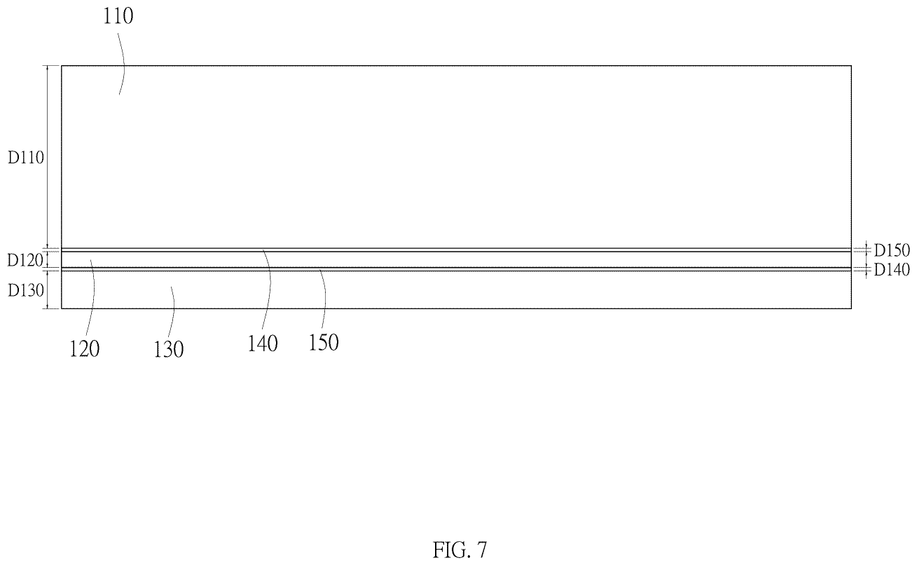

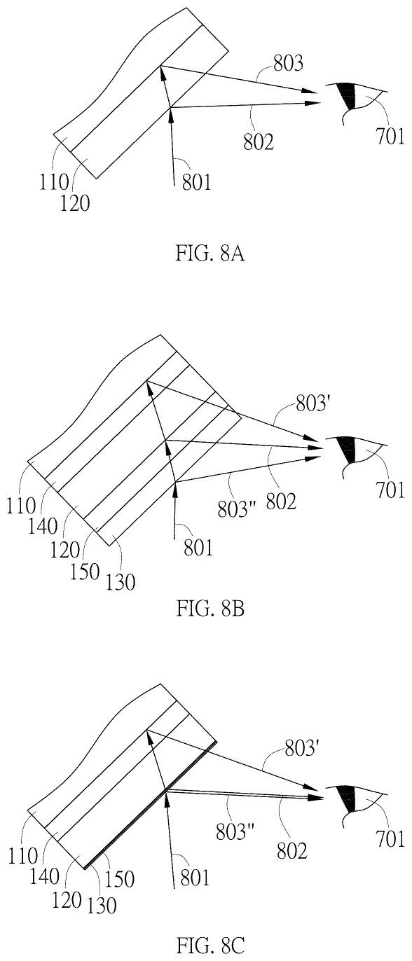

In an embodiment shown in FIG. 6, the transport vehicle front windshield structure 100 in the HUD architecture 1 of the present invention may further include an inner glass 130 bonded to a side of the composite film 120 opposite to the user 700, and a thickness of the inner glass 130 is less than a thickness of the front windshield 110, so that ghosting can be further reduced. In an embodiment shown in FIG. 7, the front windshield 110 and the composite film 120 may be bonded by a first adhesive layer 140, the composite film 120 and the inner glass 130 may be bonded by a second adhesive layer 150, and a thickness D140 of the first adhesive layer 140 and a thickness of the second adhesive layer 150 are less than a thickness D110 of the front windshield. Further, in an embodiment shown in FIG. 8A in which the inner glass is not included and an embodiment shown in FIG. 8B in which the first adhesive layer and the second adhesive layer are not included, the image light 801 is reflected to form light 802, 803, 803′, and 803″, where the light 802 forms a main image, and the light 803, the light 803′, and the light 803″ form a ghost image (that is, an undesirable image). The ghost image is significant because of a large optical path difference compared with the main image. However, referring to Table 1 and an embodiment shown in FIG. 8C below, when conditions such as that the thickness of the first adhesive layer 140 and the thickness of the second adhesive layer 150 are less than the thickness of the front windshield 110 (for example, Embodiment 3 in Table 1) or the thickness of the inner glass 130 is less than the thickness of the front windshield 110 (for example, Embodiment 2 in Table 1) are met, the optical path difference of the ghost image formed by the light 803′ and 803″ compared with the main image formed by the light 802 is reduced (compared with Embodiment 1), thereby reducing ghosting. In an embodiment, as shown in Table 1 below, the thickness of the first adhesive layer 140 is preferably greater than the thickness of the second adhesive layer 150. The thickness of the inner glass 130 is preferably greater than the thickness of the first adhesive layer 140 and the thickness of the second adhesive layer 150. Further, the first adhesive layer 140 and the second adhesive layer 150 are for the following three purposes: (1) bonding the inner glass 130, the front windshield 110, and the composite film 120 together; (2) providing the inner glass 130 and the front windshield 110 with stronger tearing resistance, to prevent scattering of glass when broken and improve their performance in a ball drop impact test; and (3) providing high light transmittance. Therefore, in an embodiment, the first adhesive layer 140 and the second adhesive layer 150 may be made of a polyvinyl butyral resin (PVB). However, the present invention is not limited thereto, and any material that can achieve the above effects and the characteristic that the thickness D140 of the first adhesive layer 140 is preferably greater than the thickness of the second adhesive layer 150 can be used. For example, Trosifol® The Wedge Monolayer series, Shadeband series, Acoustic series, Acoustic Shadeband series, and Trosifol® Clear series from Kuraray can all meet the requirements of the present invention.

TABLE 1

| | Embodiment 1 | | Embodiment 2 | | Embodiment 3 | |
|---|---|---|---|---|---|---|
| Inner glass | 2 | mm | 1.1 | mm | 2 | mm |
| Second adhesive layer | 0.76 | mm | 0.05 | mm | 0.05 | mm |
| Composite film | 0.42 | mm | 0.42 | mm | 0.42 | mm |
| First adhesive layer | 0.76 | mm | 0.76 | mm | 0.76 | mm |
| Front windshield | 2 | mm | 2 | mm | 3 | mm |

Although the present invention has been described through the foregoing related embodiments, the foregoing embodiments are merely examples for implementing the present invention. It should be noted that the disclosed embodiments are not intended to limit the scope of the present invention. Modifications and equivalent replacements made without departing from the spirit and scope of the claims shall fall within the scope of the present invention.

What is claimed is:

1. A head-up display (HUD) architecture for a transport vehicle, comprising:
a transport vehicle front windshield structure; and
a display apparatus, arranged on a side of the transport vehicle front windshield structure facing an interior of the transport vehicle and comprising a display surface facing the transport vehicle front windshield structure,
wherein image light is emitted by the display apparatus toward the transport vehicle front windshield structure in a propagation direction and reflected to an ocular point of a driver on the side of the transport vehicle front windshield structure facing the interior of the transport vehicle, a light emitting angle is defined between the propagation direction and a normal direction of the display surface, and a peak value of intensity distribution of the light emitting angle is located outside the normal direction of the display surface.

2. The HUD architecture according to claim 1, wherein the display apparatus does not comprise an optical film configured to concentrate light emitted by a light source module toward a normal of the display surface.

3. The HUD architecture according to claim 1, wherein the display apparatus further comprises a microstructure layer arranged on the display surface, the microstructure layer comprises a plurality of microstructures arranged on a side of the microstructure layer opposite to the display surface, and each of the plurality of microstructures comprises:
a bottom portion, parallel to the display surface;
a top portion, located above the bottom portion;
a first side surface, inclined toward a driver from bottom to top from a side of the bottom portion close to the transport vehicle front windshield structure, and connected to a side of the top portion close to the transport vehicle front windshield structure, wherein an inner included angle between the first side surface and the display surface is defined as α; and
a second side surface, inclined toward the transport vehicle front windshield structure from bottom to top from a side of the bottom portion away from the transport vehicle front windshield structure, and connected to a side of the top portion away from the transport vehicle front windshield structure, wherein an inner included angle between the second side surface and the display surface is defined as β,
wherein α<β, a distance between the side of the top portion close to the transport vehicle front windshield structure and the side of the top portion away from the transport vehicle front windshield structure is defined as H1, a distance between the side of the bottom portion close to the transport vehicle front windshield structure and the side of the bottom portion away from the transport vehicle front windshield structure is defined as H2, and H1<H2.

4. The HUD architecture according to claim 3, wherein H1 is greater than or equal to 0, α>0, and β is less than or equal to 90°.

5. The HUD architecture according to claim 3, wherein
$${θ}_{C} = 90 ° - 2 {θ}_{A} + {θ}_{B} ,$$
$$α = {sin}^{- 1} ( \frac{1}{N} \times sin {θ}_{C} ) ,$$
θ_{A} is an included angle between the transport vehicle front windshield structure and a head-up sight of the driver,
θ_{B} is a predefined included angle downward relative to the head-up sight of the driver, and
N is a refractive index of the microstructure.

6. The HUD architecture according to claim 1, wherein the transport vehicle front windshield structure comprises:
a front windshield; and
a composite film, bonded to a side of the front windshield opposite to the driver, and comprising a plurality of different thermoplastic resin films arranged in a stack.

7. The HUD architecture according to claim 6, wherein in a case that reflectivity (%) of each P wave incident at a first angle, a second angle greater than the first angle, and a third angle greater than the second angle relative to a normal of a film surface is defined as R_{θ1}, R_{θ2}, and R_{θ3}, a relationship of R_{θ1}≤R_{θ2}<R_{θ3} is met, wherein
$$angle A = \frac{( 180 - {θ}_{A} )}{2} ,$$
$$angle I = \frac{( 180 - {θ}_{I} )}{2} ,$$
θ_{A} is an included angle between the transport vehicle front windshield structure and a head-up sight of the driver,
θ_{I} is an included angle between the image light and the display surface,
angle A>angle I,
reflectivity at angle A<reflectivity at angle I, and
transmittance at angle A>transmittance at angle I.

8. The HUD architecture according to claim 6, wherein the transport vehicle front windshield structure further comprises an inner glass bonded to a side of the composite film opposite to the driver, and a thickness of the inner glass is less than a thickness of the front windshield.

9. The HUD architecture according to claim 6, wherein the transport vehicle front windshield structure further comprises an inner glass, the front windshield and the composite film are bonded by a first adhesive layer, the composite film and the inner glass are bonded by a second adhesive layer, and a thickness of the first adhesive layer and a thickness of the second adhesive layer are less than a thickness of the front windshield.

10. A transport vehicle front windshield structure, comprising:
a front windshield; and
a composite film, bonded to a side of the front windshield opposite to a driver, and comprising a plurality of different thermoplastic resin films arranged in a stack.

11. The transport vehicle front windshield structure according to claim 10, wherein in a case that reflectivity (%) of each P wave incident at a first angle, a second angle greater than the first angle, and a third angle greater than the second angle relative to a normal of a film surface is defined as R_{θ1}, R_{θ2}, and R_{θ3}, a relationship of R_{θ1}≤R_{θ2}<R_{θ3} is met, wherein
$$angle A = \frac{( 180 - {θ}_{A} )}{2} ,$$
$$angle I = \frac{( 180 - {θ}_{I} )}{2} ,$$
θ_{A} is an included angle between the transport vehicle front windshield structure and a head-up sight of the driver,
θ_{I} is an included angle between the image light and the display surface,
angle A>angle I,
reflectivity at angle A<reflectivity at angle I, and
transmittance at angle A>transmittance at angle I.

12. The transport vehicle front windshield structure according to claim 10, further comprising an inner glass bonded to a side of the composite film opposite to the driver, and a thickness of the inner glass is less than a thickness of the front windshield.

13. The transport vehicle front windshield structure according to claim 10, further comprising an inner glass, wherein the front windshield and the composite film are bonded by a first adhesive layer, the composite film and the inner glass are bonded by a second adhesive layer, and a thickness of the first adhesive layer and a thickness of the second adhesive layer are less than a thickness of the front windshield.
